(19) United States
(12) Patent Application Publication
(10) Pub. No.: US 2015/0255024 A1
(43) Pub. Date: Sep. 10, 2015

(54) LIQUID CRYSTAL DISPLAY METHOD AND LIQUID CRYSTAL DISPLAY DEVICE

(71) Applicant: BOE TECHNOLOGY GROUP CO., LTD., Beijing (CN)

(72) Inventor: Chunmiao Zhou, Beijing (CN)

(73) Assignee: BOE TECHNOLOGY GROUP CO., LTD., Beijing (CN)

(21) Appl. No.: 14/365,809

(22) PCT Filed: May 10, 2013
(86) PCT No.: PCT/CN2013/075492

§ 371 Date: Jun. 16, 2014

(30) Foreign Application Priority Data
Mar. 7, 2013 (CN) 201310073087.0

(51) Int. Cl. G09G 3/36

(52) U.S. Cl. CPC G09G 3/3607; G09G 2320/0242; G09G 2320/029; G09G 2320/0666; G09G 2320/08

(57) ABSTRACT

Embodiments of the disclosure provide a liquid crystal display method and a liquid crystal display device. The liquid crystal display method comprises: determining a region having a color shift feature in each frame of image; carrying out a gray-scale compensation on the region having the color shift feature; and performing a liquid crystal display according to an image data that has been compensated.

### TECHNICAL FIELD

Embodiments of the disclosure relate to a liquid crystal display technology, and more particularly, to a liquid crystal display method and a liquid crystal display device.

### BACKGROUND

Generally, capacitance coupling exists between a data line and a common line of liquid crystal display device. When the liquid crystal display device displays an image, a voltage applied to a common electrode on a color filter substrate will drift due to the capacitance coupling, which will result in a local color shift on the displayed image.

One solution is that, gray-scale compensation is carried out on the entire image with respect to each frame of image so as to avoid the color shift.

Such gray-scale compensation will influence normal display of a portion of the image free from the color shift.

Accordingly, current data compensation used for image color shift implements the gray-scale compensation on the entire image, and is apt to influence the display effect of the image region that is free from the color shift.

### SUMMARY

According to some embodiments of the disclosure, a liquid crystal display method and a liquid crystal display device are provided to improve a display effect of an image.

The liquid crystal display method according to some embodiments of the disclosure comprises: determining a region having a color shift feature in each frame of image; carrying out a gray-scale compensation on the region having the color shift feature; and performing a liquid crystal display according to an image data that has been compensated.

The liquid crystal display device according to some embodiments of the disclosure comprises: a determination unit, configured to determine a region having a color shift feature in each frame of image; a compensation unit, configured to carry out a gray-scale compensation on the region having the color shift feature; and a display unit, configured to perform a liquid crystal display according to an image data that has been compensated.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a structural schematic diagram illustrating a liquid crystal display device according to some embodiments of the disclosure.

### DESCRIPTION OF THE EMBODIMENTS

The embodiments of the disclosure provide a liquid crystal display method and a liquid crystal display device. It is to firstly determine a region having a color shift feature in each frame of image, and then carry out a gray-scale compensation on the region having the color shift feature, so that the compensation is only implemented on the portion having the color shift in the image and the compensation is not implemented on the portion free from the color shift in the image. Accordingly, display effect of the portion free from the color shift in the image is not affected and the display effect of the entire image is improved.

The liquid crystal display method according to some embodiments of the disclosure comprises:

S101. determining a region having a color shift feature in each frame of image;

S102. carrying out a gray-scale compensation on the region having the color shift feature; and

S103. performing a liquid crystal display according to an image data that has been compensated.

In the method according to the embodiments of the disclosure, the region having the color shift feature in each frame of image is determined and then the gray-scale compensation is performed for the region having the color shift feature. The gray-scale compensation is not performed on the region free from the color shift in the image. Thus, display effect of the region free from the color shift in the image is not affected and the display effect of the entire image is improved.

There are various manners to determine the region having the color shift feature in each frame of image. For example, the region having the color shift feature is determined frame by frame. Alternatively, a group of images for liquid crystal display generally have the same region with the color shift feature, and thus a certain frame of image is firstly selected to determine the region having the color shift feature, and then regions in other frames of images corresponding to this region are taken as the regions having the color shift feature in other frames of images. For example, the region having the color shift feature in a first frame is firstly determined, and then the regions in other frames of images corresponding to the region having the color shift feature in the first frame are taken as the regions having the color shift feature in other frames of images.

For example, the step S101 comprises:

S201: determining the region having the color shift feature in the first frame of image; and

S202: determining the regions in other frames of images corresponding to the region having the color shift feature in the first frame as the regions having the color shift feature in other frames of images.

The region having the color shift feature in the first frame is firstly determined, and then the regions in other frames of images corresponding to the region having the color shift feature in the first frame are determined as the regions having the color shift feature in other frames of images. In this way, the workload is reduced and the step of determining the region having the color shift feature in each frame of image is simplified. Furthermore, in order to further reduce the workload and simplify the method, the gray-scale compensation is started to be performed from a second frame of image.

For example, the step S102 comprises: performing the gray-scale compensation on the region having the color shift feature from the second frame of image.

The gray-scale compensation on the region having the color shift feature is started to be performed from the second frame of image. In this way, the workload is reduced and the method is simplified.

It should be noted that, those skilled in the art are able to determine the region having the color shift feature in each frame of image in other feasible ways and those skilled in the art are able to perform the gray-scale compensation on the region having the color shift feature in each frame of image in other feasible ways, and the details thereof are omitted here.

Various manners are available to implement the step S201, For example, a color shift detection image is set, and then the first frame of image is detected by using the color shift detection image. The color shift detection image is a problem detection image, a greenish detection image or other images suitable for color shift detection. The color shift detection image is an image same with the first frame of image under a normally displayed state, so that the region in the first frame of image different from the color shift detection image is determined as the region having the color shift feature and then the gray-scale compensation is performed on the region having the color shift feature. Alternatively, the color shift detection image is an image having a likely color shift in the first frame of image, so that the region in the first frame of image same with the color shift detection image is determined as the region having the color shift feature and then the gray-scale compensation is performed on the region having the color shift feature.

In the case that the color shift detection image is the image comprising the likely color shift in the first frame of image, the step S201 comprises: determining a region in the first frame of image having an area greater than or equal to a preset area and having a data similarity with the color shift comprised in the color shift detection image greater than or equal to a preset value as the region having the color shift feature in the first frame of image.

In order to avoid misjudgment of the region having the color shift feature in the first frame of image, a minimum image area capable of exhibiting the color shift comprised in the color shift detection image when displayed is determined according to the color shift detection image; when the region having the data similarity with the color shift comprised in the color shift detection image greater than or equal to the preset value has the area greater than or equal to the minimum image area, this region is determined as the region having the color shift feature. For example, the data similarity of the region having the color shift feature in the first frame of image with the color shift comprised in the color shift detection image is greater than or equal to 65%-80%. For example, the data similarity of the region having the color shift feature in the first frame of image with the color shift comprised in the color shift detection image is greater than or equal to 70%.

It should be noted that, those skilled in the art are able to determine the region having the color shift feature in the first frame of image in other feasible ways, and details thereof are omitted here.

For example, the region in the first frame of image having the area greater than or equal to the preset area and having the data similarity with the color shift comprised in the color shift detection image greater than or equal to the preset value is determined through a manner of detecting the first frame of image line by line, and in this case, the step 201 comprises: detecting the first frame of image line by line to determine a region consisting of no less than a preset number of continuous lines as the region having the color shift feature, wherein each line of the region at least contains a preset number of continuous data which are same with the color shift comprised in the color shift detection image.

For example, in each line, the amount of data same with the color shift comprised in the color shift detection image is 65%-80% of the total amount of data of each line. For example, in each line, the amount of data same with color shift comprised in the color shift detection image is 70% of the total amount of data of each line. The number of lines having the preset number of continuous data same with the color shift in the color shift detection image is determined according to the color shift detection image. For example, if the color shift exhibits in the case that there exist 10 continuous lines with the preset number of continuous data same with the color shift in the color shift detection image, the number of lines with the preset number of continuous data same with the color shift in the color shift detection image is set to be more than 10.

It should be noted that, those skilled in the art are able to set the number of data in each line same with the color shift in the color shift detection image and the proportion to the total data amount in each line in other feasible ways and those skilled in the art are able to set the number of lines with the preset number of continuous data same with the color shift in the color shift detection image in other feasible ways, and the details thereof are omitted here.

For example, the liquid crystal display method according to some embodiments of the disclosure comprises:

S301: inputting image data;

S302: detecting data in the first frame of image line by line until a first line with the preset number of continuous data same with the color shift in the color shift detection image is determined;

S303: recording the first line to have a line number a;

S304: detecting preset number of lines one by one from a (a+1)th line to determine whether each line at least has the preset number of continuous data same with the color shift in the color shift detection image, if so, executing step S305, if not, executing step S302;

S305: detecting remaining lines one by one until a first line failing to have the preset number of continuous data same with the color shift in the color shift detection image is determined, recording a line previous to this first line to have a line number b, and determining that the region having the color shift feature in the first frame of image is from the line a to the line b;

S306: performing the gray-scale compensation from the line a to the line b in each frame of image from the second frame, and implementing the gray-scale display according to the image data that has been compensated.

As described above, a represents the line number of the first line having the preset number of continuous data same with the color shift comprised in the color shift detection image, and b is the line number of the line previous to the first line failing to have the preset number of continuous data same with the color shift comprised in the color shift detection image. The preset number of lines in step S304 is determined according to the color shift detection image; if the color shift exhibits in the case that there exist N lines with the preset number of continuous data same with the color shift comprised in the color shift detection image, the preset number of lines determined in step S304 is N−1 lines.

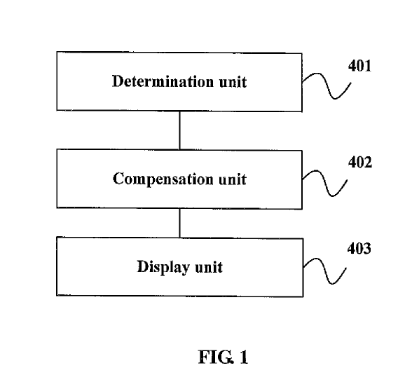

As shown in FIG. 1, the liquid crystal display device according to some embodiments of the disclosure comprises: a determination unit 401, configured to determine a region having a color shift feature in each frame of image; a compensation unit 402, configured to carry out a gray-scale compensation on the region having the color shift feature; and a display unit 403, configured to perform a liquid crystal display according to an image data that has been compensated.

In the liquid crystal display device according to the embodiments of the disclosure, the region having the color shift feature in each frame of image is determined and then the gray-scale compensation is performed on the region having the color shift feature. The gray-scale compensation is not performed on the region free from the color shift in the image. Thus, the display effect of the region free from the color shift in the image is not affected and the display effect of the entire image is improved.

There are various manners to determine the region having the color shift feature in each frame of image. For example, the region having the color shift feature is determined frame by frame. Alternatively, a group of images for liquid crystal display generally have the same region with the color shift feature, and thus a certain frame of image is firstly selected to determine the region having the color shift feature, and then regions in other frames of images corresponding to this region are taken as the regions having the color shift feature in other frames of images. For example, the region having the color shift feature in a first frame is firstly determined, and then the regions in other frames of images corresponding to the region having the color shift feature in the first frame are taken as the regions having the color shift feature in other frames of images.

For example, the determination unit 401 is configured to: determine the region having the color shift feature in the first frame of image; and determine the regions in other frames of images corresponding to the region having the color shift feature in the first frame as the regions having the color shift feature in other frames of images.

The region having the color shift feature in the first frame is firstly determined, and then the regions in other frames of images corresponding to the region having the color shift feature in the first frame are determined as the regions having the color shift feature in other frames of images. In this way, the workload in determining the region having the color shift feature in each frame of image is reduced. Furthermore, in order to further reduce the workload, the gray-scale compensation is started to be performed from a second frame of image.

For example, the compensation unit 402 is configured to: perform the gray-scale compensation on the region having the color shift feature from the second frame of image.

The gray-scale compensation on the region having the color shift feature is started to be performed from the second frame of image. In this way, the workload is reduced.

It should be noted that, those skilled in the art are able to determine the region having the color shift feature in each frame of image in other feasible ways and those skilled in the art are able to perform the gray-scale compensation on the region having the color shift feature in each frame of image in other feasible ways, and the details thereof are omitted here.

Various manners are available to determine the region having the color shift feature in the first frame of image. For example, a color shift detection image is set, and then the first frame of image is detected by using the color shift detection image. The color shift detection image is a problem detection image, a greenish detection image or other images suitable for color shift detection. The color shift detection image is an image same with the first frame of image under a normally displayed state, so that the region in the first frame of image different from the color shift detection image is determined as the region having the color shift feature and then the gray-scale compensation is performed on the region having the color shift feature. Alternatively, the color shift detection image is an image having a likely color shift in the first frame of image, so that the region in the first frame of image same with the color shift detection image is determined as the region having the color shift feature and then the gray-scale compensation is performed on the region having the color shift feature.

In the case that the color shift detection image is the image comprising the likely color shift in the first frame of image, the determination unit 401 is configured to: determine a region in the first frame of image having an area greater than or equal to a preset area and having a data similarity with the color shift comprised in the color shift detection image greater than or equal to a preset value as the region having the color shift feature in the first frame of image.

In order to avoid misjudgment of the region having the color shift feature in the first frame of image, a minimum image area capable of exhibiting the color shift comprised in the color shift detection image when displayed is determined according to the color shift detection image; when the region having the data similarity with the color shift comprised in the color shift detection image greater than or equal to the preset value has the area greater than or equal to the minimum image area, this region is determined as the region having the color shift feature. For example, the data similarity of the region having the color shift feature in the first frame of image with the color shift comprised in the color shift detection image is greater than or equal to 65%-80%. For example, the data similarity of the region having the color shift feature in the first frame of image with the color shift comprised in the color shift detection image is greater than or equal to 70%.

It should be noted that, those skilled in the art are able to determine the region having the color shift feature in the first frame of image in other feasible ways, and details thereof are omitted here.

For example, the region in the first frame of image having the area greater than or equal to the preset area and having the data similarity with the color shift comprised in the color shift detection image greater than or equal to the preset value is determined through a manner of detecting the first frame of image line by line, and in this case, the determination unit 401 is configured to: detect the first frame of image line by line to determine a region consisting of no less than a preset number of continuous lines as the region having the color shift feature, wherein each line of the region at least contains a preset number of continuous data which are same with the color shift comprised in the color shift detection image.

For example, in each line, the amount of data same with the color shift comprised in the color shift detection image is 65%-80% of the total amount of data of each line. For example, in each line, the amount of data same with color shift comprised in the color shift detection image is 70% of the total amount of data of each line. The number of lines having the preset number of continuous data same with the color shift in the color shift detection image is determined according to the color shift detection image. For example, if the color shift exhibits in the case that there exist 10 continuous lines with the preset number of continuous data same with the color shift in the color shift detection image, the number of lines with the preset number of continuous data same with the color shift in the color shift detection image is set to be more than 10.

It should be noted that, those skilled in the art are able to set the number of data in each line same with the color shift in the color shift detection image and the proportion to the total data amount in each line in other feasible ways and those skilled in the art are able to set the number of lines with the preset number of continuous data same with the color shift in the color shift detection image in other feasible ways, and the details thereof are omitted here.

For example, the determination unit 401 is configured to:

detect data in the first frame of image line by line until a first line with the preset number of continuous data same with the color shift in the color shift detection image is determined, and record the first line to have a line number a;

detect preset number of lines one by one from a (a+1)th line to determine whether each line at least has the preset number of continuous data same with the color shift in the color shift detection image;

detect remaining lines one by one until a first line failing to have the preset number of continuous data same with the color shift in the color shift detection image is determined, and record a line previous to this first line to have a line number b, and determine that the region having the color shift feature in the first frame of image is from the line a to the line b.

As described above, a represents the line number of the first line having the preset number of continuous data same with the color shift comprised in the color shift detection image, and b is the line number of the line previous to the first line failing to have the preset number of continuous data same with the color shift comprised in the color shift detection image. The preset number of lines as described above is determined according to the color shift detection image; if the color shift exhibits in the case that there exist N lines with the preset number of continuous data same with the color shift comprised in the color shift detection image, the preset number of lines as described above is N−1 lines.

The liquid crystal display device according to the embodiments of the disclosure is a device corresponding to the liquid crystal display method according to the embodiments of the disclosure, and is applicable to all embodiments of the liquid crystal display method provided in the disclosure,

The embodiments of the disclosure provide the liquid crystal display method and the liquid crystal display device. It is to firstly determine the region having the color shift feature in each frame of image, and then carry out the gray-scale compensation on the region having the color shift feature, so that compensation is only implemented on the region having the color shift in the image and the compensation is not implemented on the region free from the color shift in the image. Accordingly, the display effect of the region free from the color shift in the image is not affected and the display effect of the entire image is improved.

Those skilled in the art shall understand that the embodiments of the disclosure are able to be provided as a method, a system or a computer program product. Therefore, the disclosure can adopt forms of a complete hardware embodiment, a complete software embodiment or embodiment combining software and hardware. In addition, the disclosure can adopt the form of computer program product that is implemented on one or more computer applicable storage mediums (comprising, but not limited, disk memory, CD-ROM, optical memory, etc.) comprising computer applicable program codes therein.

The disclosure is described herein with reference to flowchart charts and/or block diagrams of methods, apparatuses (systems), and computer program products according to the embodiments of the disclosure. It should be understood that each flow and/or block in the flowchart and/or block diagram, and a combination of flow and/or block in the flowchart and/or block diagram can be implemented by computer program instructions. These computer program instructions may be provided to a general purpose computer, a special purpose computer, an embedded processor or a processor of other programmable data processing apparatus to form a machine, such that devices for implementing functions specified by one or more flows in the flowchart and/or one or more blocks in the block diagram may be generated by executing the instructions with the processor of the computer or other programmable data processing apparatus.

These computer program instructions may also be stored in a computer-readable memory that can direct the computer or other programmable data processing apparatus to operate in a given manner, so that the instructions stored in the computer-readable memory produce a manufactured article comprising an instruction device, and the instruction device implements the functions specified by one or more flows in the flowchart and/or one or more blocks in the block diagram.

These computer program instructions may also be loaded onto the computer or other programmable data processing apparatus, such that a series of process steps may be executed on the computer or other programmable data processing apparatus to produce process implemented by the computer, thereby, the instructions executed on the computer or other programmable data processing apparatus provide steps of implementing the functions specified by one or more flows in the flowchart and/or one or more blocks in the block diagram.

The foregoing embodiments merely are exemplary embodiments of the disclosure, and not intended to define the scope of the disclosure, and the scope of the disclosure is determined by the appended claims.

1. A liquid crystal display method, comprising:
determining a region having a color shift feature in each frame of image;
carrying out a gray-scale compensation on the region having the color shift feature;
performing a liquid crystal display according to an image data that has been compensated;
wherein the determining the region having the color shift feature in each frame of image comprises:
determining a region in a first frame of image having an area greater than or equal to a preset area and having a data similarity with a color shift comprised in a color shift detection image greater than or equal to a preset value as the region having the color shift feature in the first frame of image;
and determining regions in other frames of images corresponding to the region having the color shift feature in the first frame as the regions having the color shift feature in other frames of images.

2. The method according to claim 1, wherein
the carrying out the gray-scale compensation on the region having the color shift feature comprises: carrying out the gray-scale compensation on the region having the color shift feature from a second frame of image.

3. (canceled)

4. The method according to claim 1, wherein the determining the region in the first frame of image having the area greater than or equal to the preset area and having the data similarity with the color shift comprised in the color shift detection image greater than or equal to the preset value as the region having the color shift feature in the first frame of image, comprises:
detecting the first frame of image line by line to determine a region consisting of no less than a preset number of continuous lines as the region having the color shift feature, wherein each line of the region at least contains a preset number of continuous data which are same with the color shift comprised in the color shift detection image.

5. The method according to claim 4, wherein the detecting the first frame of image line by line to determine the region consisting of no less than the preset number of continuous lines comprises:
detecting data in the first frame of image line by line until a first line with the preset number of continuous data same with the color shift in the color shift detection image is determined, and recording the first line to have a line number a;
detecting preset number of lines one by one from a (a+1)th line to determine whether each line at least has the preset number of continuous data same with the color shift comprised in the color shift detection image;
detecting remaining lines one by one until a first line failing to have the preset number of continuous data same with the color shift in the color shift detection image is determined, recording a line previous to this first line to have a line number b, and determining that the region having the color shift feature in the first frame of image is from the line a to the line b.

6. A liquid crystal display device, comprising:
a determination unit, configured to determine a region having a color shift feature in each frame of image;
a compensation unit, configured to carry out a gray-scale compensation on the region having the color shift feature; and
a display unit, configured to perform a liquid crystal display according to an image data that has been compensated;
wherein the determination unit is configured to: determining a region in a first frame of image having an area greater than or equal to a preset area and having a data similarity with a color shift comprised in a color shift detection image greater than or equal to a preset value as the region having the color shift feature in the first frame of image;
and determine regions in other frames of images corresponding to the region having the color shift feature in the first frame as the regions having the color shift feature in other frames of images.

7. The device according to claim 6, wherein
the compensation unit is configured to: carry out the gray-scale compensation on the region having the color shift feature from a second frame of image.

8. (canceled)

9. The device according to claim 6, wherein the determining the region in the first frame of image having the area greater than or equal to the preset area and having the data similarity with the color shift comprised in the color shift detection image greater than or equal to the preset value as the region having the color shift feature in the first frame of image by the determination unit, comprises:
detecting the first frame of image line by line to determine a region consisting of no less than a preset number of continuous lines as the region having the color shift feature, wherein each line of the region at least contains a preset number of continuous data which are same with the color shift comprised in the color shift detection image.

10. The device according to claim 9, wherein the detecting the first frame of image line by line to determine the region consisting of no less than the preset number of continuous lines by the determination unit comprises:
detecting data in the first frame of image line by line until a first line with the preset number of continuous data same with the color shift in the color shift detection image is determined, and recording the first line to have a line number a;
detecting preset number of lines one by one from a (a+1)th line to determine whether each line at least has the preset number of continuous data same with the color shift comprised in the color shift detection image;
detecting remaining lines one by one until a first line failing to have the preset number of continuous data same with the color shift in the color shift detection image is determined, recording a line previous to this first line to have a line number b, and determining that the region having the color shift feature in the first frame of image is from the line a to the line b.
